(19) United States
(12) Patent Application Publication
(10) Pub. No.: US 2017/0232986 A1
(43) Pub. Date: Aug. 17, 2017

(54) Keg Transporter

(71) Applicant: John Donald Root, JR., Pinehurst, NC (US)

(72) Inventor: John Donald Root, JR., Pinehurst, NC (US)

(21) Appl. No.: 15/408,510

(22) Filed: Jan. 18, 2017

Related U.S. Application Data
(60) Provisional application No. 62/295,239, filed on Feb. 15, 2016.

(51) Int. Cl. B62B 1/26; B62B 1/06

(52) U.S. Cl. CPC B62B 1/264; B62B 1/06; B62B 2202/02

(57) ABSTRACT

A keg transporter. The keg transporter includes a base having a pair of opposing ends, a pair of wheels, wherein each individual wheel is rotatably connected to one of the opposing ends of the base, and a vertical member extending upwardly from the base. A horizontal bar is disposed on the vertical member, and a pair of support arms extends therefrom. A pair of handles is disposed on opposing sides of an upper end of the vertical member, and a support hook disposed on the vertical member between the handle and the horizontal bar. The support hook fits through the opening of a beer keg handle and supports the keg along with the pair of support arms. The keg transporter allows individuals to easily transport a heavy keg over varying terrain.

### CROSS REFERENCE TO RELATED APPLICATIONS

This application claims the benefit of U.S. Provisional Application No. 62/295,239 filed on Feb. 15, 2016. The above identified patent application is herein incorporated by reference in its entirety to provide continuity of disclosure.

### BACKGROUND OF THE INVENTION

The present invention relates to two-wheeled transport carts. More specifically, the present invention provides a keg transporter having two-ground support wheels, a support hook for supporting the handle portion of a keg thereon, and a pair of support arms for supporting the lower portion of the keg.

Beer is often stored in large metal kegs. A filled keg is heavy and very difficult to move. Some individuals move kegs by laying them on their side and rolling them, but this can ruin the carbonated beverages stored therein. A standard two wheeled dolly may be used to transport the keg, but the rounded shape of the keg may cause it to roll off of the dolly, potentially causing damage to the keg or to surrounding objects or individuals. The keg typically has handles to assist users in moving it. However, it can be awkward and difficult to move the heavy keg by hand, and doing so often requires two individuals to lift the keg, which may not always be present. Additionally, an individual may injure themselves when lifting the heavy keg. In order to address these concerns, the present invention provides a keg transporter that supports the handle portion of a keg via a support hook and supports the lower end of the keg via a pair of opposing support arms, such that the keg may be transported on a pair of wheels across varying terrain.

Devices have been disclosed in the known art that relate to carts and other transportation devices. These include devices that have been patented and published in patent application publications. These devices generally relate to keg transportation devices, such as U.S. Pat. No. 2,673,654, U.S. Pat. No. 773,027, U.S. Pat. No. 2,181,438, U.S. Pat. No. 6,086,310, and U.S. Pat. No. 4,762,333.

The devices disclosed in the known art have several evident drawbacks. Some of the devices provide transportation carts for kegs having a four wheeled construction and multiple folding members, which are complex and expensive to produce. Other devices in the known art are configured to transport a keg but include various fasteners that make it difficult to attach the keg to the device and subsequently remove it. Further, the devices in the known art fail to provide a keg transporter having a combination of a support hook that supports the keg on the transporter via one of the keg handles and a pair of opposing support arms that support the lower end of the keg during transport.

In light of the devices disclosed in the prior art, it is submitted that the present invention substantially diverges in design elements from the prior art and consequently it is clear that there is a need in the art for an improvement to existing keg transport devices. In this regard the instant invention substantially fulfills these needs.

### SUMMARY OF THE INVENTION

In view of the foregoing disadvantages inherent in the known types of keg transporters now present in the prior art, the present invention provides a keg transporter wherein the same can be utilized for providing convenience for the user when transporting a keg over varied terrain. The keg transporter includes a base having a pair of opposing ends, a pair of wheels rotatably connected to the opposing ends of the base, and a vertical member disposed on the base extending upwardly therefrom. A horizontal bar having a first end and a second end is disposed on the vertical member. A first support arm is connected to the first end of the horizontal bar, and a second support arm is connected to the second end of the horizontal bar. A pair of handles are disposed on opposing sides of an upper end of the vertical member, and a support hook is disposed on the vertical member between the handle and the horizontal bar. The support hook is sized to fit through the a handle opening of a keg to support the keg thereon, and the first and second support arms are sized to contact the sides of the keg, supporting the keg in an upright position when the keg transporter is in use.

One object of the present invention is to provide a keg transporter having all of the advantages of prior art devices with none of the disadvantages.

Another object of the present invention is to provide a keg transporter having handles with non-slip grips disposed thereon.

A further object of the present invention is to provide a keg transporter having a kickstand disposed on a rear side of the base, wherein the kickstand is moveable between a stored position and a deployed position, wherein the kickstand is configured to maintain the keg transporter in an upright position when the kickstand is in the deployed position.

Other objects, features, and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a front perspective view of the beer keg transporter.

FIG. 2 shows a rear perspective view of the beer keg transporter.

FIG. 3 shows a side perspective view of the beer keg transporter in use.

### DETAILED DESCRIPTION OF THE INVENTION

Reference is made herein to the attached drawings. Like reference numerals are used throughout the drawings to depict like or similar elements of the keg transporter. For the purposes of presenting a brief and clear description of the present invention, the preferred embodiment will be discussed as used for wheeled transport of a keg. The figures are intended for representative purposes only and should not be considered to be limiting in any respect.

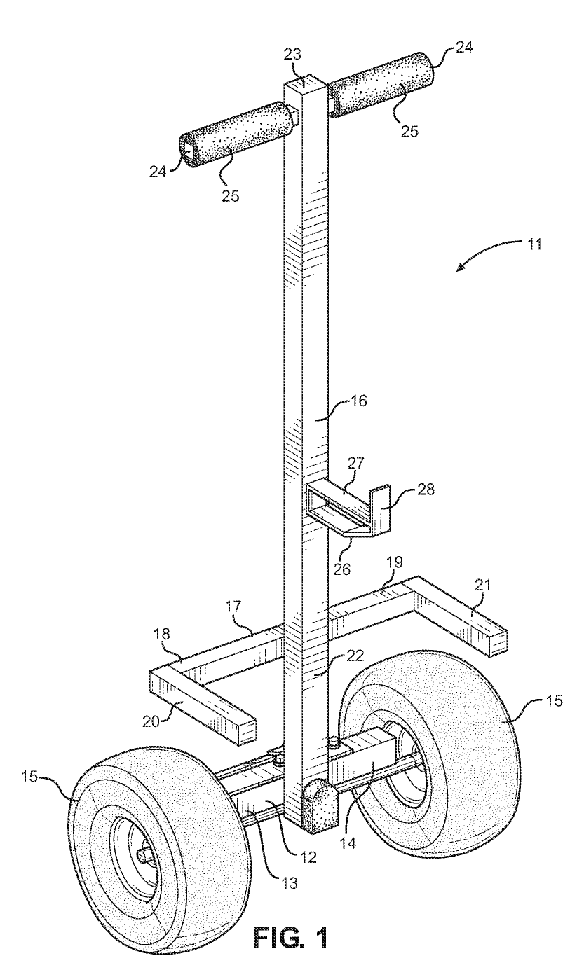

Referring now to FIG. 1, there is shown a front perspective view of the beer keg transporter. The keg transporter 11 generally comprises a base 12 having a first end 13 and an opposing second end 14. A pair of wheels 15 are each disposed on the first and second ends 13, 14 of the base 12. The pair of wheels may be rotatably secured to the base 12 directly, or may be rotatably mounted to an axle secured to the base 12.

A vertical member 16 is secured to the base 12 and extends upwardly therefrom. A pair of handles 24 are disposed in an opposing relationship to one another on opposing sides of an upper end 23 of the vertical member 16. In the illustrated embodiment, a grip 25 is disposed on each handle 24. The grip 25 is preferably composed of a non-slip material such as rubber or foam in order to assist a user when grasping the handles 24.

A support hook 26 is disposed on the vertical member 16 between the handles 24 and the base 12. The support hook 26 includes a horizontal portion 27 that extends outward perpendicularly from the vertical member 16, and a vertical portion 28 that extends upward and is perpendicular to the horizontal portion 27. The support hook 26 is sized so as to fit through the standard handle opening of a beer keg. The support hook 26 supports the weight of the beer keg during transport thereof.

A horizontal bar 17 is disposed on the vertical member 16 toward a lower end 22 thereof. Particularly, the horizontal bar 17 is disposed on the vertical member 16 between the support hook 26 and the base 12. A first support arm 20 is disposed on a first end 18 of the horizontal bar 17 and extends perpendicularly therefrom. Similarly, a second support arm 21 is disposed on an opposing second end 19 of the horizontal bar 17 and extends perpendicularly therefrom. In the illustrated embodiment, the base, vertical member, horizontal bar, first support arm and second support arm comprises a square cross-section. However, an alternate embodiment may utilize a tubular construction with circular cross sections.

The support arms 20, 21 extend from the horizontal bar 17 in the same direction as the support hook 26 extending from the vertical member 16. The support arms 20, 21 support a lower end of a keg during transport thereof. In one embodiment, the distance between the support arms 20, 21 is 16⅛ inches, which corresponds to the width of a standard sized keg. This allows the keg to be secured between the support arms 20, 21 and prevents lateral movement of the keg during transport.

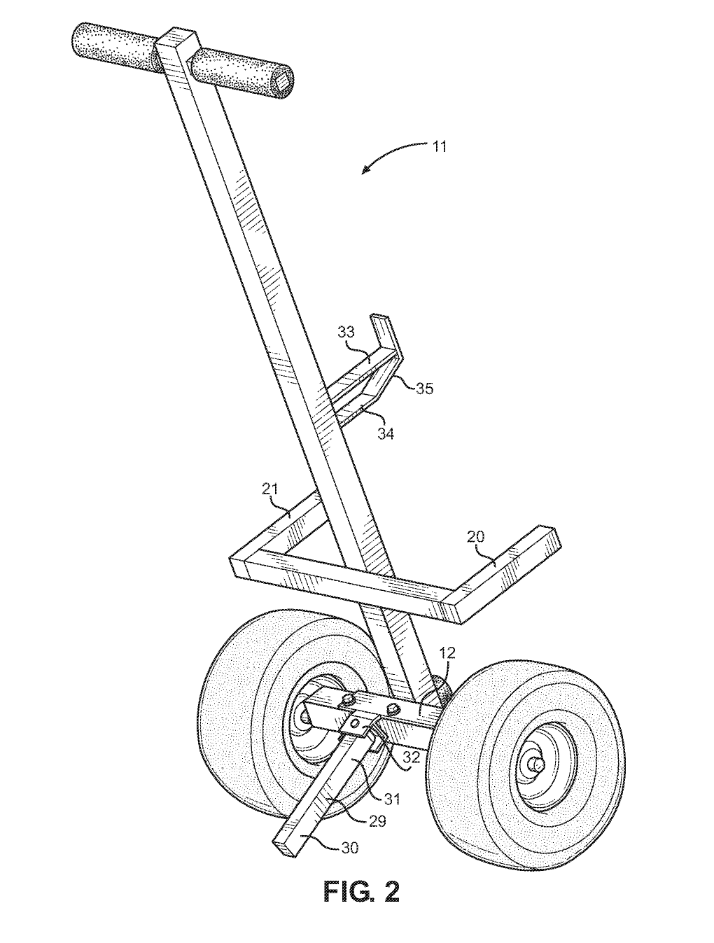

Referring now to FIG. 2, there is shown a rear perspective view of the beer keg transporter. In the shown embodiment, the support hook comprises an upper horizontal member 33 and a lower horizontal member 34 parallel thereto. A lower angled member 35 is connected to the lower horizontal member 34 and extends upward therefrom, making contact with the upper horizontal member 33. In an alternate embodiment, the support hook may be a uniform construction.

The keg transporter 11 further comprises a kickstand 29 disposed on a rear side of the base 12, preferably at a midpoint thereof. The kickstand 29 includes a first end 30 that supports the keg transporter 11 in an upright position, and a second end 31 that connects to the base 12 via a hinge 32. The hinge 32 is configured to maintain the kickstand 30 in either a deployed position, wherein the kickstand 29 extends perpendicularly from the rear side of the base 12, or a stored position, wherein the kickstand 30 is folded against the base 12 such that it is parallel thereto. The kickstand 29 is preferably utilized to maintain the keg transporter in an upright position when the keg transporter is not being used to transport a keg. When the keg transporter is in use, the kickstand 29 may be secured in the stored position, so that it is out of the way when an individual is transporting a keg.

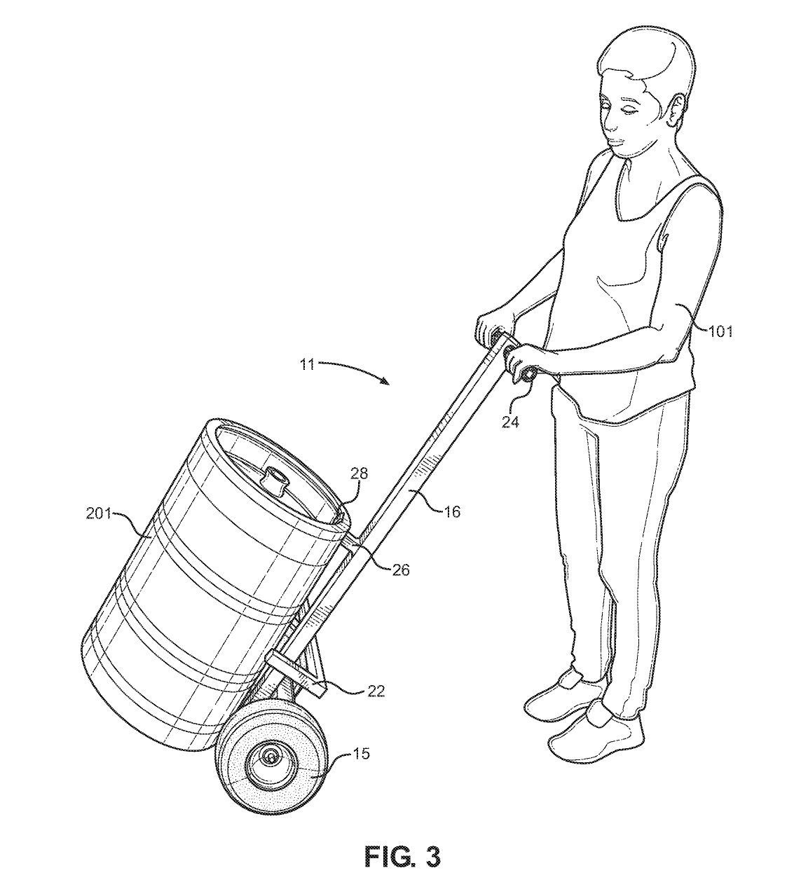

Referring now to FIG. 3, there is shown a side perspective view of the beer keg transporter in use. A keg 201 is shown with the support hook 26 inserted through the handle opening. The horizontal portion of the support hook 26 supports a lower edge of the handle opening while the vertical portion of the support hook 26 supports an inner edge of the keg 201 sidewall. Additionally, the support arms 22 support the lower end of the keg 201.

The keg 201 may be secured to the keg transporter 11 via the support hook 26 and support arms 22 when both the keg transporter 11 and keg 201 are in an upright position. In use, an individual 101 hooks the support hook 26 into the keg handle opening, grasps the keg transporter handles 24, and applies a downward force thereto. The downward force causes the keg 201 to tilt backward toward the individual 101, transferring the weight of the keg 201 from the ground to the wheels 15. In this way, the vertical member 16 acts as a lever and the wheels 15 act as a fulcrum, allowing the keg 201 to be easily tilted backward and subsequently rolled along a surface. The support hook 26 and the support arms 22 support the keg 201 during transportation, preventing the keg 201 from falling off of the keg transporter 11. Therefore, the keg transporter 11 provides for easy transportation of a keg 201.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A keg transporter, comprising:
a base having a pair of opposing ends;
a pair of wheels, wherein each individual wheel is rotatably connected to one of the opposing ends of the base;
a vertical member extending upwardly from the base;
a horizontal bar disposed on the vertical member, the horizontal bar having a first end and a second end;
a first support arm connected to the first end of the horizontal bar;
a second support arm connected to the second end of the horizontal bar;
a pair of handles disposed on opposing sides of an upper end of the vertical member; and
a support hook disposed on the vertical member between the handle and the horizontal bar;
wherein the support hook is sized to fit through a handle opening of a keg.

2) The keg transporter of claim 1, wherein the pair of support arms are spaced from one another such that a keg is received therebetween.

3) The keg transporter of claim 1, wherein each support arm is perpendicular to the horizontal bar.

4) The keg transporter of claim 1, wherein the support hook comprises a horizontal member connected to the base and vertical member disposed on the horizontal member perpendicular thereto and extending upward therefrom.

5) The keg transporter of claim 1, further comprising:
a kickstand disposed on the base, wherein the kickstand is moveable between a stored position and a deployed position, wherein the kickstand is configured to maintain the keg transporter in an upright position when the kickstand is in the deployed position.

6) The keg transporter of claim 5, wherein the kickstand further comprises:
a first member having a first end and a second end, the first end hingedly connected to the base.

7) The keg transporter of claim 1, wherein each of the pair of handles comprises a grip thereon, the grip being formed from a non-slip material.

8) The keg transporter of claim 1, wherein each of the base, vertical member, horizontal bar, first support arm, and second support arm comprises a square cross-section.
